(19) United States
(12) Patent Application Publication
(10) Pub. No.: US 2012/0057026 A1
(43) Pub. Date: Mar. 8, 2012

(54) MONITORING SYSTEM

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/889,560

(22) Filed: Sep. 24, 2010

(30) Foreign Application Priority Data
Sep. 3, 2010 (TW) 99129958

(51) Int. Cl. H04N 7/18; G10L 19/00

(52) U.S. Cl. 348/159; 704/500; 704/E19.001; 348/E07.085

(57) ABSTRACT

A monitoring system includes a monitoring apparatus, a television, and a number of cameras. The monitoring apparatus includes an image analog-to-digital (A/D) converting unit to receive images from the cameras and convert the received analog images to digital images. A microcontroller receives the digital images from the image A/D converting unit, and compresses the received digital images and stores the compressed digital images in the storage unit. An image digital-to-analog (D/A) converting unit receives the digital images from the microcontroller and converts the received digital images to analog images. When the microcontroller receives the control signal from the television, the microcontroller outputs the received digital images to the image D/A converting unit, to convert the received digital images to analog images and output the analog images to the television. The microcontroller compresses the received digital images and stores the compressed digital images in a storage unit.

### BACKGROUND

1. Technical Field

The present disclosure relates to a monitoring system.

2. Description of Related Art

Network cameras are typically employed for monitoring a location. Using a network video recorder or video management software in a personal computer (PC), video data from all the cameras are recorded simultaneously. For example, each of the network cameras captures video data, and transmits the video data to the PC through a high-frequency band. Before displaying video images on a display screen of the PC, parameters of the PC may be set to decode the video data. However, it is a difficult for users who are unfamiliar with PCs to set the parameters. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a monitoring system, the monitoring system includes a monitoring apparatus.

FIG. 2 is a block diagram of the monitoring apparatus of FIG. 1.

### DETAILED DESCRIPTION

The disclosure, including the drawings, is illustrated by way of example and not by limitation. It should be noted that references to “an” or “one” embodiment in this disclosure are not necessarily to the same embodiment, and such references mean at least one.

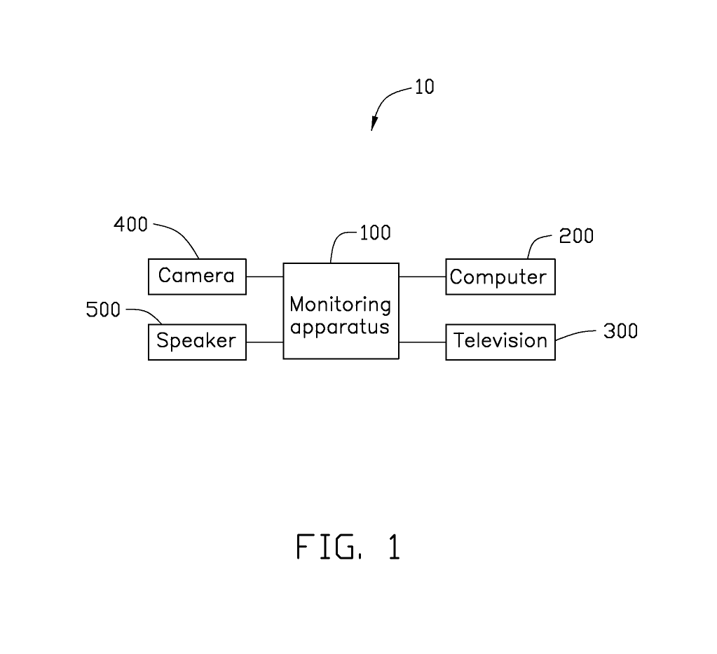

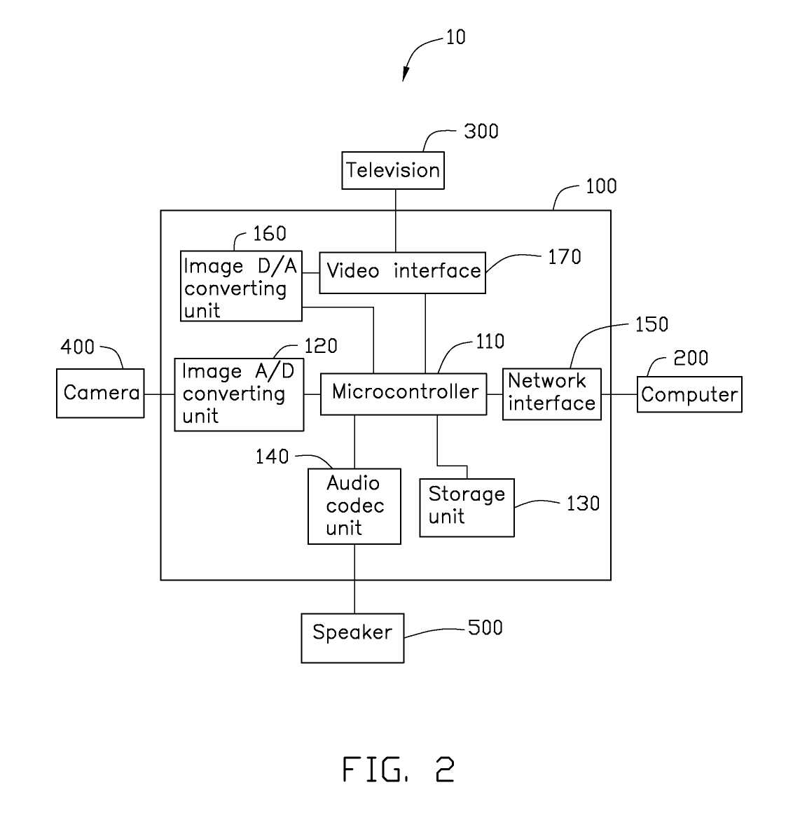

Referring to FIGS. 1 and 2, an embodiment of a monitoring system 10 includes a monitoring apparatus 100, a computer 200, a television 300, a number of cameras 400, and a speaker 500. The monitoring apparatus 100 includes a microcontroller 110, an image analog-to-digital (A/D) converting unit 120, a storage unit 130, an audio codec unit 140, a network interface 150, an image digital-to-analog (D/A) converting unit 160, and a video interface 170.

The cameras 400 are configured to capture images of a location, and output captured analog images to the image A/D converting unit 120. The image A/D converting unit 120 converts the received analog images to digital images and outputs the converted digital images to the microcontroller 110. The microcontroller 110 compresses the received digital images and stores the compressed digital images in the storage unit 130 according to a first control signal from the computer 200 or a second control signal from the television 300. If the microcontroller 110 receives the first control signal from the computer 200, the microcontroller 110 also outputs the digital images to the computer 200 through the network interface 150. At the same time, the microcontroller 110 outputs the digital image signals to the audio codec unit 140. The audio codec unit 140 decodes audio signals of the digital image signals and outputs the decoded audio signals through the speaker 500. If the microcontroller 110 receives the second control signal from the television 300, the microcontroller 110 also outputs the digital images to the image D/A converting unit 160. The D/A converting unit 160 converts the received digital images to analog images and outputs the converted analog images to the television 300 through the video interface 170. Images of the location can be displayed on the monitor of the computer 200 through executing programs of the computer 200, or can be displayed on the television 300 by switching the monitoring state of the television 300. In other embodiments, the microcontroller 110 can wirelessly communicate with the computer 200.

In use, if a location needs to be monitored by the computer 200, the computer 200 outputs the first control signal to the microcontroller 110 of the monitoring apparatus 100. The microcontroller 110 outputs received digital images from the image A/D converting unit 120 to the computer 200 according to the first control signal. At the same time, the microcontroller 110 compresses the received digital images and stores the compressed digital images in the storage unit 130, and outputs the received digital image signals to the audio codec unit 140 to decode audio signals of the digital image signals and output the decoded audio signals through the speaker 500. Therefore, the location can be monitored by the computer 200. If the location needs to be monitored by the television 300, the television 300 can be switched to a monitoring state, and then the television 300 outputs the second control signal to the microcontroller 110 of the monitoring apparatus 100. The microcontroller 110 outputs the received digital images from the image A/D converting unit 120 to the image D/A converting unit 160. The image D/A converting unit 160 converts the received digital images to analog images and outputs the converted analog images to the television 300. At the same time, the microcontroller 110 compresses the received digital images and stores the compressed digital images in the storage unit 130, and outputs the received digital image signals to the audio codec unit 140 to decode audio signals of the digital image signals and output the decoded audio signals through the speaker 500. Therefore the location can be monitored by the television 300.

The monitoring system 10 not only can monitor the location by the computer 200, but also can monitor the location by the television 300. Therefore, the monitoring system 10 can be used conveniently by a user who is unfamiliar with computers.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A monitoring system comprising:
a television;
a plurality of cameras to capture analog images of a location; and
a monitoring apparatus comprising:
an image analog-to-digital (A/D) converting unit, to receive the captured analog images from the plurality of cameras and convert the received analog images to digital images;
a storage unit;
a microcontroller, to receive the digital images from the image A/D converting unit, and compress the received digital images and store the compressed digital images in the storage unit according a first control signal from the television; and
an image digital-to-analog (D/A) converting unit, to receive the digital images from the microcontroller and convert the received digital images to analog images;
wherein when the microcontroller receives the first control signal from the television, the microcontroller outputs the received digital images to the image D/A converting unit, the D/A converting unit converts the received digital images to analog images and outputs the converted analog images to the television, and the microcontroller compresses the received digital images and stores the compressed digital images in the storage unit.

2. The monitoring system of claim 1, further comprising a computer, wherein the monitoring apparatus further comprises a network interface, the microcontroller is connected to the computer through the network interface, wherein when the microcontroller receives a second control signal from the computer through the network interface, the microcontroller outputs the received digital images from the image A/D converting unit to the computer, and the microcontroller compresses the received digital images and stores the compressed digital images in the storage unit.

3. The monitoring system of claim 1, further comprising a speaker, wherein the monitoring apparatus further comprises an audio codec unit, wherein the audio codec unit receives the digital image signals from the microcontroller, decodes audio signals of the received digital image signals, and outputs the decoded audio signals through the speaker.
